(19) United States
(12) Patent Application Publication
(10) Pub. No.: US 2026/0277469 A1
(43) Pub. Date: Sep. 17, 2026

(54) OUT OF MEMORY MANAGEMENT

(71) Applicant: SAP SE, Walldorf (DE)

(72) Inventor: Dirk Thomsen, Heidelberg (DE)

(21) Appl. No.: 19/080,507

(22) Filed: Mar. 14, 2025

(51) Int. Cl. G06F 3/06

(52) U.S. Cl. CPC G06F 3/0656; G06F 3/0604; G06F 3/0652; G06F 3/0673

(57) ABSTRACT

Embodiments of the present disclosure include techniques for improving out of memory management. In one embodiment, an out of memory (OOM) reserve buffer is used to store data pages when a page buffer is out of memory. The OOM reserve buffer includes a counter that counts a number of data pages in the OOM reserve buffer where both (i) a particular data page in the OOM reserve buffer has zero pointers directed at it and (ii) the particular data page has been sent to a write component to be written to the persistent memory. A request to add a new data page to the OOM reserve buffer is denied if the counter is zero, but if the counter is greater than zero, the system automatically waits a time period and then adds the new data page.

### BACKGROUND

The present disclosure relates generally to memory management in computer software systems, and in particular, to out of memory management.

Computer systems often store data in different types of memory. For faster access, data is often stored in a fast volatile memory, such as random access memory (RAM). However, RAM loses data when power is removed. Persistent memory retains information after power is removed. Accordingly, computer systems also typically store data in various forms of persistent memory, such as hard disk drives and/or solid state drives (e.g., flash memory).

When multiple types of memories are used, data in the system is typically moved back and forth between RAM and persistent memory. One challenge with moving data between memories pertains to out of memory conditions. In an out of memory condition, a memory component of the system may not be able to store any additional data during an input/output operation with persistent memory. Such conditions can slow down the operation of the system and cause deleterious effects on applications using the data.

The following disclosure provides various technical solutions to overcome issues related to moving data on and off of persistent memory.

### BRIEF DESCRIPTION OF THE DRAWINGS

FIG. 1 illustrates an out of memory management system according to an embodiment.

FIG. 2 illustrates an out of memory management method according to an embodiment.

FIG. 3 illustrates an example database system and out of memory management method according to an embodiment.

FIG. 4 illustrates example linked pages according to an embodiment.

FIG. 5 illustrates hardware of a special purpose computing system configured according to the above disclosure.

### DETAILED DESCRIPTION

Described herein are techniques for out of memory management. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

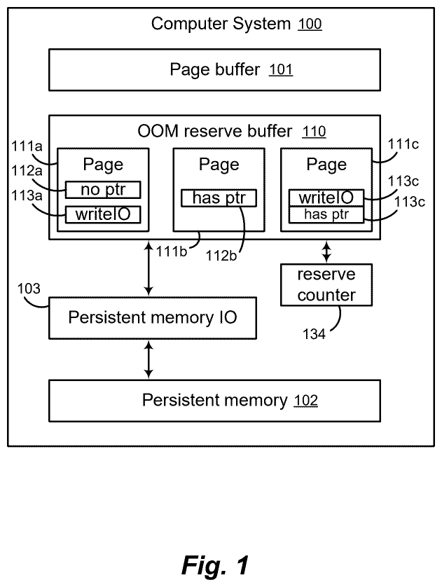

FIG. 1 illustrates a system for out of memory management according to an embodiment. Computer system 100 may include, for example, one or more computers comprising one or more processors and a computer readable medium (memory) for executing software to perform the techniques described herein. Here, embodiments of the present disclosure include techniques for storing data pages in an out of memory (OOM) reserve buffer 110 when a page buffer 101 is out of memory. Advantageously, the system may determine when there is going to be available memory in the OOM reserve buffer 110 by examining the state of data pages 111a-c in the OOM reserve buffer. Requests to add new data pages to the OOM reserve buffer 110 may be granted after a wait time period or denied based on the status of data pages 111a-c, for example.

In particular, data pages may be stored in a page buffer 101 as the data pages are moved in and out of persistent memory 102. Thus, page buffer 101 may be associated with reading and writing the data pages to a persistent memory 102, for example. A data page is a block of data associated with software construct, such as a table, container, or file, for example. A table of data, for example, may be divided into data pages having a particular maximum page size (e.g., 16 MB). Related data pages (e.g., from a column of a table) may be coupled together using a variety of techniques, such as B+trees, linked lists, or the like. As data pages are manipulated by various software programs in main memory (e.g., a volatile memory such as RAM), the data pages are periodically stored in a persistent memory to safeguard the state of the data (e.g., in a non-volatile memory such as a hard disk drive (HDD) or solid state drive (SDD)).

Typically, data pages being written to, or read from, persistent memory 102 are stored in page buffer 101. However, in some situations page buffer 101 may fill up and an out of memory flag may be generated. In response to determining that the page buffer 101 is full (e.g., an out of memory state is detected), OOM reserve buffer 110 is used to store data pages 111a-c. In some embodiments, OOM reserve buffer 110 may be part of the page buffer 101 allocated on startup, for example. Processing data pages 111a-c may be carried out based on certain status of each page. For example, in some cases one more pointers may be directed at a particular data page. Pointers may be part of certain operations being carried out by the computer system that used data in the data page, for example. In some cases, when a data page is associated with a pointer (a pointer is pointing at, or direct at, the data page), the system may be restricted from deleting the data page. However, when there are zero pointers directed at a particular data page, the system may not be restricted from deleting the data page. As illustrated in FIG. 1, data page 111a has a status 112a indicating that zero pointers (no ptr) are directed at the page. Conversely, data pages 111b-c have a status that at least one pointer (has ptr) is directed at the page. As described below, in some example embodiments, pointer status and writeIO information may be stored in a control block associated with each page and pointer information (has_ptr or no_ptr) may be stored as a counter that counts a number of pointers referencing a page, for example.

Similarly, when a data page is written to persistent memory 102, the data page may be sent to a write component to be written to persistent memory. In this illustration, the write component is depicted as persistent memory IO 103. When the particular data page has been sent to the write component to be written to the persistent memory, the page may have a status indicating the page has been sent to persistent memory I/O 103. In FIG. 1, page 111a has a status writeIO 113a indicating that page 111a has been sent to persistent memory IO 103. Similarly, page 111c has a status writeIO 113c indicating that page 111c has been sent to persistent memory IO 103.

Features and advantages of the present disclosure include a technique for determining when OOM reserve buffer 110 will have memory space available in the future based on one or more status indicators of data pages in the OOM reserve buffer 110. For instance, if a request to store a new data page in OOM reserve buffer 110 is received and the OOM reserve buffer is full, the request may be denied. However, if the status of data pages in the OOM reserve buffer indicates that memory will be available soon, then a wait time period may be used to accept a new data page in the buffer without issuing a rejection, thereby advantageously speeding up data processing and improving out of memory management conditions.

For instance, embodiments of the present disclosure may include a reserve counter 134 associated with OOM reserve buffer 110. Reserve counter 134 counts a number of data pages in OOM reserve buffer 110 meeting both of the following criteria: (i) a particular data page in OOM reserve buffer has zero pointers directed at the particular data page and (ii) the particular data page has been sent to a write component to be written to the persistent memory. As illustrated in FIG. 1, data page 111a has zero pointers directed at it (as determined by “no ptr” status 112a) and it has been sent to persistent memory IO 103 (as determined by “writeIO” status 113a). Thus, the count equals 1 in this simple example. Accordingly, even though page 111a is currently in OOM reserve buffer 110 and the OOM reserve buffer is full, the count indicates that page 111a will be deleted as soon as persistent memory IO completes the process of writing it to persistent memory 102.

Advantageously, when a request is received to add a new data page to the OOM reserve buffer 110, the request may be processed based on the counter. For instance, when the counter is greater than zero when the request is received, the system may wait a time period and recheck the counter (e.g., to determine if there is space available in the OOM reserve buffer) before adding the new data page to the OOM reserve buffer. Alternatively, when the counter is zero when the request is received, the request denied.

One particular challenge with out of memory situations is in the case of pages that are linked together. Certain operations (e.g., a rollback) can require iterating over page chains. If the pages are modified, pages may build up in writeIO (e.g., persistent memory IO 103) after pointers to the pages are released. The backlog in the writeIO can cause the system to crash in some cases. In various embodiments that incorporate the writeIO status and pointer status (e.g., using reserve counter 134), a writeIO backlog and crash may be advantageously avoided, for example.

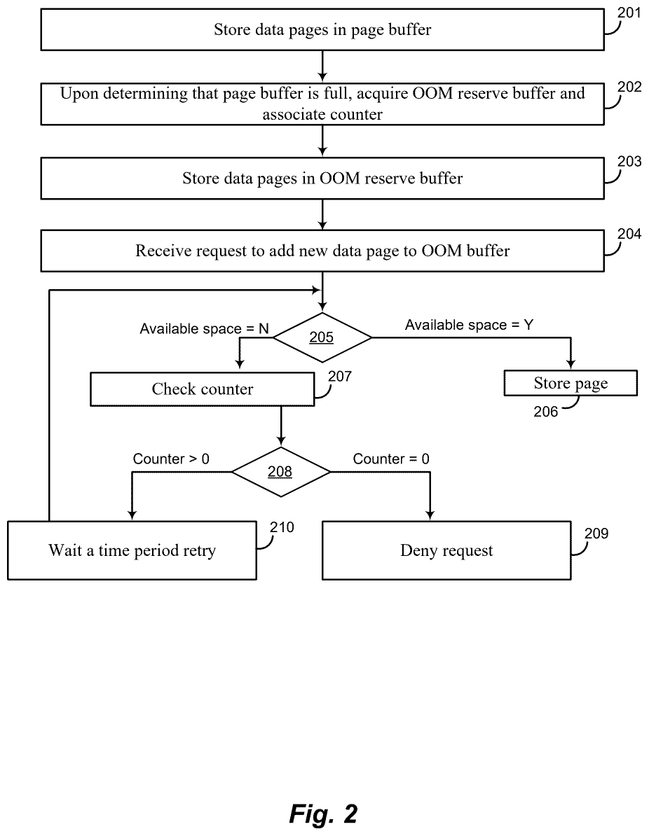

FIG. 2 illustrates an out of memory management method according to an embodiment. At 201, a first plurality data pages is stored in a page buffer associated with reading and writing the data pages to a persistent memory. An OOM reserve buffer may be allocated on startup with a counter. At 202, upon determining that the page buffer is full, the OOM reserve buffer is may be acquired with an associated counter. At 203, a second plurality of data pages is stored in the OOM reserve buffer. As mentioned above, some example embodiment may store control blocks with each data page as well. At 204, a request is received to add a new data page to the OOM reserve buffer. At 205, the system determines if there is available space in the OOM reserve buffer. If there is available space, the page is stored in the OOM reserve buffer at 206. If there is no available space, the system checks the reserve counter at 207. The counter counts a number of data pages in the OOM reserve buffer meeting both of the following criteria (i) a particular data page of the second plurality of data pages has zero pointers directed at the particular data page and (ii) the particular data page has been sent to a write component to be written to the persistent memory. At 208, the method branches based on the count. When the counter is zero (e.g., indicating no additional OOM memory will be available in the foreseeable future), the system denies the request at 209. However, when the counter is greater zero (e.g., indicating additional OOM memory will be available in the foreseeable future), the system waits a time period before returning to 205 to recheck space and the counter. If space is now available (e.g., when a page with a pointer count of zero has been written to disk and deleted), the new page may be saved, for example.

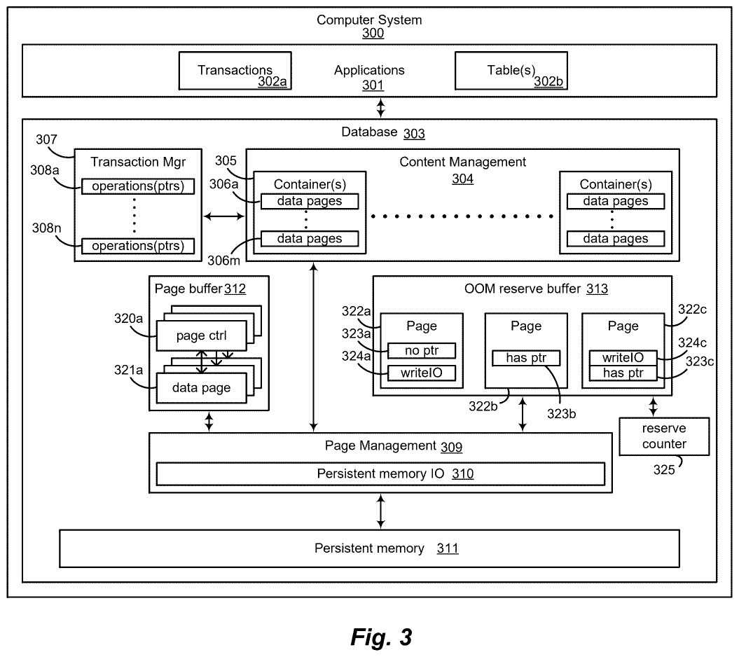

FIG. 3 illustrates an example system according to an embodiment. In this example, the techniques described herein are applied to a database system. For instance, a page buffer, a OOM reserve buffer, and the persistent memory are components of a database. The page buffer and the OOM reserve buffer may be configured in a volatile memory (e.g., RAM) and the persistent memory may be a non-volatile memory (e.g., HDD or SSD), for example. Computer system 300 may include a plurality of applications 301 executing on one or more processors on one or more computers (e.g., servers or virtual machines). Applications 301 may execute various transactions 302a and on tables of data 302b. Data 302b may also be stored in database 303, and transactions 302a may be managed in database 303 by transaction manager 307. Transaction manager 307 maps transactions to database operations 308a-n, for example. Data is managed by content management 304. For example, for a table with multiple columns, one or more containers 305 may be created in RAM to store the data in the table. In one embodiment, each column of a table may be stored in a different container. In various embodiments, containers are collections of data pages in RAM, which are then stored to persistent memory (aka, disk). Containers may be implemented using B-trees or linked lists, for example. In some embodiments, entries in the containers may be fixed in size (e.g., 240 Bytes) or variable (e.g., for variable characters). In certain embodiments, entries stored in the containers may not exceed a maximum page size, for example. In some cases, data in database 303 is converted to data pages. In this example, a column of table data is stored as data pages 306a-m in container 305. Data pages, in turn, may be manipulated by operations 308a-n. Thus, operations 308a-n may include pointers (“ptrs”) to data pages. In some embodiments, the pointers are part of objects, referred to as handles, associated with the operations, for example.

Data pages are written to and read from persistent memory 311 by a page management component 309. Page management 309 may use a page buffer 312 to temporarily store data pages being written to or read from persistent memory. Page buffer 312 is sometimes referred to as a page cache, data buffer, or resource container. Contents of the page buffer (e.g., pages from containers) may be stored to persistent memory 311 as is, for example. In this example, each of the data pages (e.g., page 321a) in page buffer 312 and OOM reserve buffer 313 is associated with a page control block (e.g., page ctrl 320a; not shown in OOM reserve buffer). A page control block maintains transient information for the page. In this example, a page control block may include various parameter values, such as a reference counter parameter (“refCnt”, e.g., corresponding to a number of pointers pointing to the particular data page), an indication of whether or not the page is modified (isModified), a parameter value indicating a particular data page has been sent to a write component (e.g., persistent memory IO 310) to be written to the persistent memory 311 (“inIO”), and other transient page information, for example. The reference counter parameter may be increased when new pointers for certain operations point to the page and the reference counter parameter may be decreased when the pointers are terminated (e.g., when the pointer is destroyed or deallocated upon completion of an operation). In some embodiments, the reference counter parameter may count how many threads point to a particular page and may be able to modify the page, for example.

The present example illustrates one advantageous application of the techniques described herein. If page buffer 312 runs out of memory, an out of memory (OOM) reserve buffer 313 (aka, OOM memory) may be used to store certain pages to ensure the particular transactions are completed without causing a system crash. In one example embodiment, the OOM reserve buffer 313 is set to 6 times a maximum page size (e.g., 6× largest page size=6×16 MB). For example, if 6 pages at a time are loaded, it requires 6× the largest page size (e.g., 6× the largest page size plus 6× the pages size of the control block). For example, if an OOM condition occurs during a rollback with only a portion of the data transaction complete, the database may be left in an unacceptable condition that may lead to a database crash. Some transactions require the entire transaction to be completed or the system must rollback. For example, a transaction may needed to be rolled back such that the data currently changed within the transaction must be reverted to its initial state. In particular, if a transaction is performing a debit of one bank account and a credit to another bank account, both cells must be updated or neither are updated. Accordingly, an OOM condition impeding the rollback is not an acceptable situation. If a particular data page was written to disk and is no longer in page buffer 312, the data must be read out of the disk to reverse the operation. Accordingly, in this example, there must be memory available to receive the data pages. However, if page buffer 312 is full, the system detects the OOM condition of the page buffer and allocates memory for OOM reserve buffer 313. In some embodiments, the OOM reserve buffer is restricted for use by only one operation at a time, and other operations experiencing an OOM condition are placed in a wait state. However, managing the operation of the OOM reserve buffer 313 also presents a challenge.

Here, data pages 322a-c are loaded into the OOM. If any of the data pages are unmodified and associated with zero pointers, such data pages may be deleted from the OOM reserve buffer 313. However, if a page is modified (isModified=True), the pointer is released (refCnt decreases), and the page sent to persistent memory IO 310 (aka, write IO) to be written to disk. Generally, page management 309 may write and/or read pages to and/from persistent memory 311 using persistent memory IO 310 (aka, writeIO or pageIO). In one example embodiment, when a page is sent to persistent memory IO 310 to be written to disk, the inIO parameter is set to True, and when the write IO process is done, the inIO parameter is reset to False. Accordingly, if the write IO process is done (inIO=False) and there are no pointers associated with the page, then the page in the OOM may be deleted. In some embodiments, each data page may be restricted from deletion from the OOM reserve buffer 313 when the data page is associated with one or more pointers (e.g., to preserve the operations). Typically, each data page, when modified, may be restricted from deletion from the OOM reserve buffer 313 until a write complete/done signal (inIO=False) is detected (e.g., to ensure the write is completed successfully before deleting the page). However, problems can arise if OOM reserve buffer 313 loads multiple linked pages. As pages are loaded, the OOM reserve buffer may run out of memory space (e.g., if pages are loaded with active pointers and that cannot be deleted). Furthermore, even in cases where the number of pointers associated with a page drops to zero (allowing for deletion of the page), a page is typically only be deleted when the write IO is done. In this example, the write IO is triggered when the page's refCnt is zero and the page is modified (isModified=True). For example, the system may detect (e.g., from a page control block) that a particular data page was modified and send the particular data page to the write IO to be written to the persistent memory 311. In this case, if the persistent memory IO 310 is slow, the OOM reserve buffer 313 may fill up with pages that could otherwise be deleted (e.g., if the system waits for inIO to transition from True to False).

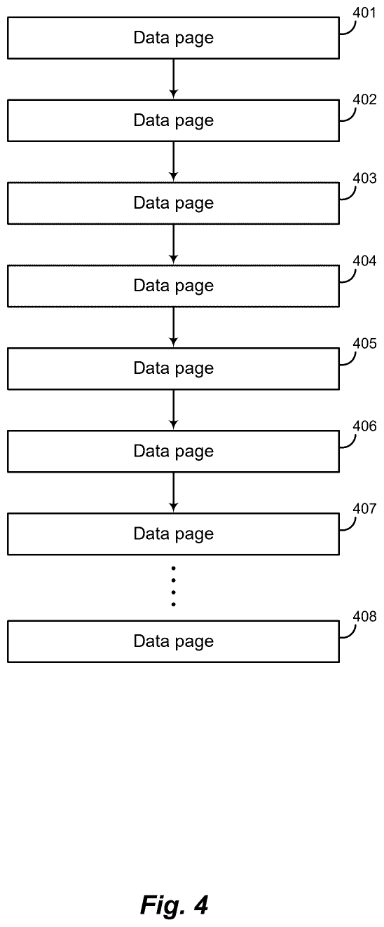

FIG. 4 illustrates example linked pages according to an embodiment. For this example, it may be desirable to store linked data pages 401-408 in OOM reserve buffer 313. However, OOM reserve buffer 313 may only be able to store a portion of data pages 401-408. The following example illustrates how the improved techniques described herein ensure that OOM reserve buffer 313 does not cause a loss of data due to an overflow. The following illustrates an example algorithm for iterating over the chain of linked pages in FIG. 4:

PageIterator iter=container.begin( ); // internally load the first page and allocate the memory
While (iter) // while the PageIterator is valid (e.g., we are not at the end of the page chain)
   {
      PageHandle hPage=*iter; // get a copy of the PageHandle
      hPage→modify( ); // use the PageHandle to modify the page
      ++iter; // move the PageIterator (ptr) to the next page
   }

In this example, PageIterator is a C++ class that holds a handle (e.g., a pointer) to that page as a data member in a data structure pointing to the control block for the page. Holding a handle to that page means that the Page has a refCount of 1 (i.e., only 1 handle points to the page). Thus, the first data page 401 may be loaded into OOM reserve buffer 313 with one pointer associated with the page. Upon entry into the while loop, a second page handle is acquired resulting in a refCount of 2 for page 401 (e.g., one for hPage and one for the member of PageIterator). PageHandle is used to modify the page. The “++iter” is used to move the PageIterator pointer to the next page (e.g., page 402). This reduces the refCount on the previous page (e.g., refCount for page 401 changes from 2 to 1) and increases the refCount for the new page (e.g., refCount for page 402 increases to 1). Additionally, hPage goes out goes out-of-scope and the pointer is deleted, which reduces the refCount for the previous page (e.g., page 401) to 0. Because the page was modified, it will be sent the write-IO.

As can be seen in this example, iterating over the page chain, there is a maximum of two pages which currently have refCnt>0 (e.g., directly linked pages such as 401 and 402). Accordingly, the system may use memory for maximum of two pages at a time, if there wouldn't be the problem with writeIO delay mentioned above. As mentioned above, putting a page into write IO will also set the boolean inIO-flag for this page to TRUE. Finishing the write IO will reset the inIO flag for the page to FALSE, as mentioned above. However, a page with (a) refCnt>0 or (b) being in write-IO cannot be evicted from memory, in this example, as there is (a) someone who keeps a handle to the page and might access the page or (b) will write the page to disk. Looking at the above algorithm for iterating over the page chain, it may appear that the system needs to have memory for maximum two pages only. However, proper performance requires consideration of memory for pages with refCnt=0 (no pointers) but which are still in write IO (where inIO has not yet transitioned from True to False indicating the write is done), and hence cannot be deleted from OOM reserve buffer 313. How many additional pages are kept in memory depends on how fast one iteration over the while-loop is compared with the write IO. If the write IO is extremely fast compared to the time spent for one iteration in the while-loop, the system may end up with only one additional page. However, if the write IO is extremely slow compared with the time spent for one iteration in the while-loop, the system may attempt to put all pages in OOM memory at the same time, hence triggering an overflow of the OOM reserve buffer 313. For instance, if the system is performing a rollback with hundreds or thousands of linked pages, the OOM reserve buffer will not be able to hold all the pages and the system may crash.

From the above operation, it can be seen that having a page with (refCount=0 && inIO=true) means that no operation has a pointer to that page, but it cannot be evicted from OOM memory because it is still in write IO (e.g., where inIO indicates a data page has been sent to a write IO to be written to the persistent memory, but may not be completed yet). However, the page will be available for deletion from OOM memory the moment the write IO is finished (e.g., when inIO transitions back to False). Accordingly, if pages have a state transition from “(refCount==0 && inIO==true)” to “!(refCount==0 && inIO==true)” or the other way around, the number of pages being currently in write IO with zero pointers may be determined. Accordingly, the system may determine that memory will become available in a few moments and can just wait. However, if the OOM memory is out-of-memory and there are no such pages, the system can throw OOM condition for the OOM memory and not allow any further pages to be placed in the OOM memory.

Accordingly, a reserve counter 325 (aka, OOMctr) is associated with the OOM reserve buffer 313 to count the number of pages sent to write IO with zero pointers pointing at them and which can be deleted upon completion of the write IO process, for example. The reserve counter 325 counts a number of pages with refcount=0 (no handles/ptrs) that are still in write IO (e.g., inIO=True, and cannot be deleted), which will be deleted from OOM memory when the write IO finishes and memory will become available. Reserve counter 325 counts a number of pages with refCnt=0 && InIO=true. Reference counter 325 may increase the count when a data page in OOM memory transitions to a state having refCnt value equal to zero and write IO equal to true (e.g., in the example above inIO=True). Reference counter may decrease the count when a data page is deleted from the OOM reserve buffer, for example. Accordingly, if counter 325 is greater than zero when a request to add a new page into OOM memory is received, the system waits a time period before rechecking the count and availability of the OOM reserve buffer. After the time period, a page is deleted(e.g., refCnt==0 && inIO==false) and a new page may be added. In particular, a size in bytes of the new data page is less than or equal to a size in bytes of the deleted data page. However, when there is no OOM memory available and the counter is zero when the request is received, the request is denied. In one example embodiment, if the system attempts to allocate a page to OOM memory and there is no space available, then if OOMctr=0, there is no space and no pages in write IO, so no space will be available. Accordingly, the system denies the allocation request. However, if OOMcrt>0, then OOM memory space is coming soon. Thus, the system may wait and retry as described above.

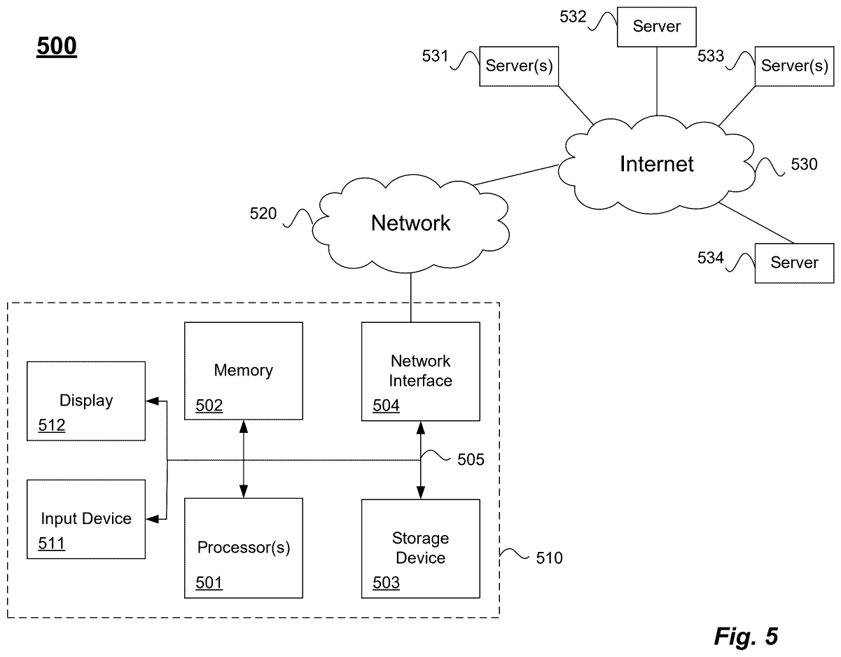

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: storing a first plurality data pages in a page buffer associated with reading and writing the data pages to a persistent memory; upon determining that the page buffer is full, allocating an out of memory (OOM) reserve buffer; storing a second plurality of data pages in the OOM reserve buffer; associating a counter with the OOM reserve buffer, wherein the counter counts a number of data pages in the OOM reserve buffer meeting both of the following criteria (i) a particular data page of the second plurality of data pages has zero pointers directed at the particular data page and (ii) the particular data page has been sent to a write component to be written to the persistent memory; and receiving a request to add a new data page to the OOM reserve buffer, wherein when the counter is greater than zero when the request is received, waiting a time period before adding the new data page to the OOM reserve buffer, and wherein when the counter is zero when the request is received, denying the request.

In one embodiment, the method includes waiting the time period, checking the counter, wherein the new data page is added to the OOM reserve buffer when space is available in the OOM reserve buffer

In one embodiment, the method further comprises storing, for each of the second plurality of data pages, (i) a first value indicating a second number corresponding to a number of pointers pointing to the particular data page and (ii) a second value indicating the particular data page has been sent to the write component to be written to the persistent memory.

In one embodiment, the method includes increasing the counter when one of the second plurality of data pages transitions to a state having a first value equal to zero and a second value equal to true.

In one embodiment, the method includes decreasing the counter when said one of the second plurality of data pages is deleted from the OOM reserve buffer.

In one embodiment, the second plurality of data pages and the new data page are associated with an operation, and wherein the OOM reserve buffer is restricted for use by only one operation at a time.

In one embodiment, the particular data page is deleted from the OOM reserve memory after being written to the persistent memory.

In one embodiment, a size in bytes of the new data page is less than or equal to a size in bytes of the particular data page.

In one embodiment, the method further comprises detecting that the particular data page of the second plurality of data pages was modified and sending the particular data page to the write component to be written to the persistent memory, wherein a time to write the particular data page to persistent memory is less than the time period.

In one embodiment, any one of second plurality of data pages is restricted from deletion from the OOM reserve buffer when said any one of the second plurality of data pages is associated with one or more pointers.

In one embodiment, any one of the second plurality of data pages, when modified, are restricted from deletion from the OOM reserve buffer until a write complete signal is detected.

In one embodiment, the particular page is sent to the write component to be written to the persistent memory when the particular page is modified and the particular page has zero pointers directed at the particular data page.

In one embodiment, when any one of the second plurality of data pages is unmodified and associated with zero pointers, said any one of the second plurality of data page is deleted from the OOM reserve buffer.

In one embodiment, the page buffer and the OOM reserve buffer are configured in a volatile memory, and wherein the persistent memory is a non-volatile memory.

In one embodiment, the page buffer, the OOM reserve buffer, and the persistent memory are components of a database.

In another embodiment, the present disclosure includes a computer system comprising: one or more processors; volatile memory; non-volatile memory; and a database system configured to perform a method comprising: storing tabular data for one or more applications in a plurality of containers in the volatile memory, each container comprising a plurality of data pages; receiving a plurality of database transactions from the one or more applications, the plurality of database transactions corresponding to operations on the tabular data, the operations comprising pointers to a portion of the data pages; storing a first plurality data pages in a page buffer associated with reading and writing the data pages to the non-volatile memory; upon determining that the page buffer is full, allocating an out of memory (OOM) reserve buffer; storing a second plurality of data pages in the OOM reserve buffer; associating a counter with the OOM reserve buffer, wherein the counter counts a number of data pages in the OOM reserve buffer meeting both of the following criteria (i) a particular data page of the second plurality of data pages has zero of said pointers directed at the particular data page and (ii) the particular data page has been sent to a write component to be written to the persistent memory; and receiving a request to add a new data page to the OOM reserve buffer, wherein when the counter is greater than zero when the request is received, waiting a time period before adding the new data page to the OOM reserve buffer, and wherein when the counter is when the request is received, denying the request.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
storing a first plurality data pages in a page buffer associated with reading and writing the data pages to a persistent memory;
upon determining that the page buffer is full, storing a second plurality of data pages in an OOM reserve buffer;
associating a counter with the OOM reserve buffer, wherein the counter counts a number of data pages in the OOM reserve buffer meeting both of the following criteria (i) a particular data page of the second plurality of data pages has zero pointers directed at the particular data page and (ii) the particular data page has been sent to a write component to be written to the persistent memory; and
receiving a request to add a new data page to the OOM reserve buffer, wherein when the counter is greater than zero when the request is received, waiting a time period before adding the new data page to the OOM reserve buffer, and wherein when the counter is zero when the request is received, denying the request.

2. The method of claim 1, wherein, after waiting the time period, checking the counter, wherein the new data page is added to the OOM reserve buffer when space is available in the OOM reserve buffer.

3. The method of claim 1, further comprising storing, for each of the second plurality of data pages, (i) a first value indicating a second number corresponding to a number of pointers pointing to the particular data page and (ii) a second value indicating the particular data page has been sent to the write component to be written to the persistent memory.

4. The method of claim 3, further comprising increasing the counter when one of the second plurality of data pages transitions to a state having a first value equal to zero and a second value equal to true.

5. The method of claim 3, further comprising decreasing the counter when said one of the second plurality of data pages is deleted from the OOM reserve buffer.

4. The method of claim 1, wherein the second plurality of data pages and the new data page are associated with an operation, and wherein the OOM reserve buffer is restricted for use by only one operation at a time.

5. The method of claim 1, wherein the particular data page is deleted from the OOM reserve memory after being written to the persistent memory.

8. The method of claim 7, wherein a size in bytes of the new data page is less than or equal to a size in bytes of the particular data page.

9. The method of claim 7, further comprising detecting that the particular data page of the second plurality of data pages was modified and sending the particular data page to the write component to be written to the persistent memory, wherein a time to write the particular data page to persistent memory is less than the time period.

6. The method of claim 1, wherein any one of second plurality of data pages is restricted from deletion from the OOM reserve buffer when said any one of the second plurality of data pages is associated with one or more pointers.

7. The method of claim 1, wherein any one of the second plurality of data pages, when modified, are restricted from deletion from the OOM reserve buffer until a write complete signal is detected.

8. The method of claim 1, wherein the particular page is sent to the write component to be written to the persistent memory when the particular page is modified and the particular page has zero pointers directed at the particular data page.

9. The method of claim 1, wherein when any one of the second plurality of data pages is unmodified and associated with zero pointers, said any one of the second plurality of data page is deleted from the OOM reserve buffer.

10. The method of claim 1, wherein the page buffer and the OOM reserve buffer are configured in a volatile memory, and wherein the persistent memory is a non-volatile memory.

11. The method of claim 1, wherein the page buffer, the OOM reserve buffer, and the persistent memory are components of a database.

12. A computer system comprising:
one or more processors;
volatile memory;
non-volatile memory; and
a database system configured to perform a method comprising:
storing tabular data for one or more applications in a plurality of containers in the volatile memory, each container comprising a plurality of data pages;
receiving a plurality of database transactions from the one or more applications, the plurality of database transactions corresponding to operations on the tabular data, the operations comprising pointers to a portion of the data pages;
storing a first plurality data pages in a page buffer associated with reading and writing the data pages to the non-volatile memory;
upon determining that the page buffer is full, storing a second plurality of data pages in an OOM reserve buffer;
associating a counter with the OOM reserve buffer, wherein the counter counts a number of data pages in the OOM reserve buffer meeting both of the following criteria (i) a particular data page of the second plurality of data pages has zero of said pointers directed at the particular data page and (ii) the particular data page has been sent to a write component to be written to the persistent memory; and
receiving a request to add a new data page to the OOM reserve buffer, wherein when the counter is greater than zero when the request is received, waiting a time period before adding the new data page to the OOM reserve buffer, and wherein when the counter is zero when the request is received, denying the request.

13. A non-transitory computer-readable medium storing computer-executable instructions that, when executed by at least one processor of a computer system, cause the computer system to execute method comprising:
storing a first plurality data pages in a page buffer associated with reading and writing the data pages to a persistent memory;
upon determining that the page buffer is full, storing a second plurality of data pages in an OOM reserve buffer;
associating a counter with the OOM reserve buffer, wherein the counter counts a number of data pages in the OOM reserve buffer meeting both of the following criteria (i) a particular data page of the second plurality of data pages has zero pointers directed at the particular data page and (ii) the particular data page has been sent to a write component to be written to the persistent memory; and
receiving a request to add a new data page to the OOM reserve buffer, wherein when the counter is greater than zero when the request is received, waiting a time period before adding the new data page to the OOM reserve buffer, and wherein when the counter is zero when the request is received, denying the request.

18. The non-transitory computer-readable medium of claim 17, further comprising storing, for each of the second plurality of data pages, (i) a first value indicating a second number corresponding to a number of pointers pointing to the particular data page and (ii) a second value indicating the particular data page has been sent to the write component to be written to the persistent memory.

19. The non-transitory computer-readable medium of claim 17, wherein the particular page is sent to the write component to be written to the persistent memory when the particular page is modified and the particular page has zero pointers directed at the particular data page.

20. The non-transitory computer-readable medium of claim 17, wherein the page buffer and the OOM reserve buffer are configured in a volatile memory, and wherein the persistent memory is a non-volatile memory.
